(19) United States
(12) Patent Application Publication
(10) Pub. No.: US 2017/0170548 A1
(43) Pub. Date: Jun. 15, 2017

(54) ANTENNA FOR FULL-METAL BACK COVER AND MOBILE TERMINAL

(71) Applicants: LE HOLDINGS (BEIJING) CO., LTD., Beijing (CN); Lemobile Information Technology (Beijing) Co., Ltd., Beijing (CN)

(72) Inventors: Lishan HUANG, Beijing (CN); Wei LI, Beijing (CN)

(21) Appl. No.: 15/236,346

(22) Filed: Aug. 12, 2016

Related U.S. Application Data
(63) Continuation of application No. PCT/CN2016/089089, filed on Jul. 7, 2016.

(30) Foreign Application Priority Data
Dec. 11, 2015 (CN) 201510921115.9

(51) Int. Cl. H01Q 1/24; H01Q 1/50

(52) U.S. Cl. CPC H01Q 1/243; H01Q 1/50

(57) ABSTRACT

An embodiment of the present disclosure discloses an antenna for a full-metal back cover and a mobile terminal. The antenna fur a full-metal back cover comprises a parasitic antenna resonance part disposed on an assembled part of a mobile terminal; when the mobile terminal is assembled, the parasitic antenna resonance part and an antenna body disposed on a full-metal back cover are in a position correspondence relationship; the antenna body comprises an antenna feed unit, an antenna grounding unit and an antenna radiation part; and the parasitic antenna resonance part and the antenna radiation part are in a coupled relationship. The antenna for a full-metal back cover and the mobile terminal provided by the embodiment of the present disclosure realize an effect of expanding antenna frequency band, improve antenna performance and save antenna design space and project development cost.

### CROSS-REFERENCE TO RELATED APPLICATIONS

This application is a continuation of International Application No. PCT/CN2016/089089, filed on Jul. 7, 2016, which claims priority to Chinese Patent Application No. 201510921115.9, entitled “ANTENNA FOR FULL-METAL BACK COVER AND MOBILE TERMINAL”, filed Dec. 11, 2015, the entire contents of all of which are incorporated herein by reference.

### FIELD OF TECHNOLOGY

The present disclosure generally relates to the parasitic antenna field, in particular to an antenna for a full-metal back cover and a mobile terminal.

### BACKGROUND

Along with the increase in users of mobile terminals and rise in a ratio of smart mobile phones, rapid development of LTE drive mobile terminals to upgrade faster and faster. Mobile phone antenna as a very important non-standard constitutional component of a mobile phone constrains the overall performance of wireless transmission of the mobile phone. At present, traditional mobile phone antennas fail to meet requirements of wireless communication of LTE. Small-sized mobile phone antennas with an ultra-wide-band have become a research hot spot of the current communication industry. Therefore, the mobile phone's development trend to small size, multi-frequency and wide-band has great research significance.

In mobile phone market, mobile phones made from metal have advantages of firmness, a good hand feel, a good appearance, etc., of which mobile phones with metal back covers perform better. However, along with the popularization of LTE, mobile phone antennas are required to cover a frequency band which is wide enough, that is a great challenge for the mobile phone with a metal back cover.

How to design an ultra-wide-band antenna for a mobile phone with a full-metal back cover is a very challenging difficulty for antenna engineers.

At present, in the prior art, performance of many mobile antennas in different frequency bands are optimized by adding a switch or a tuner at an antenna feed point, thereby achieving a wide frequency band.

However, such solution has the following disadvantages:

in this way, the consumption of import varies with the placement, match, layout, etc. of devices. Therein, radio frequency, antenna and printed wiring board (PWB) engineers are needed to estimate the optimal position and wiring in the pre-stage advanced search. If the design is poor, the consumption of import will exceed the advantages brought by the switch or turner.

Therefore, how to provide a new design of an antenna for a full-metal back cover, which meets wide-band requirements and a mobile terminal, is a technical problem to be solved.

### SUMMARY

An embodiment of the present disclosure discloses an antenna for a full-metal back cover and a mobile terminal to overcome defects in the prior art, and to realize a new design solution of an antenna for a full-metal back cover and a mobile terminal.

To solve the problem, embodiment of the present disclosure discloses an antenna for a full-metal back cover, comprising: a parasitic antenna resonance part disposed on an assembled part in a mobile terminal; wherein when the mobile terminal is assembled, the position of the parasitic antenna resonance part corresponds to the position of an antenna body disposed on a full-metal back cover; the antenna body comprises an antenna feed unit, an antenna grounding unit and an antenna radiation part; and the parasitic antenna resonance part and the antenna radiation part are coupled.

To solve the problem, embodiment of the present disclosure discloses a mobile terminal with a full-metal back over, comprising an antenna system, characterized in that, the antenna system comprises: an antenna body disposed on the full-metal back cover, the antenna body comprising an antenna feed unit, an antenna grounding unit and an antenna radiation part; a parasitic antenna resonance part disposed on an assembled part in the mobile terminal; wherein, when the mobile terminal is assembled, the position of the parasitic antenna resonance part corresponds to the position of the antenna body; and the parasitic antenna resonance part and the antenna radiation part are coupled.

In the antenna for a full-metal back cover and a mobile terminal provided by the embodiment of the present disclosure, the parasitic antenna resonance part is disposed on an assembled part in the mobile terminal in an innovative way, and the antenna frequency band is expanded through coupling between a parasitic antenna and a metal back cover, thereby achieving the effect of expanding the antenna frequency band. In this way, the tuner at the antenna feed point can be canceled, saving cost. Besides, the space, occupied by the turner, on the PWB can be excavated, and the increase in the space is also favorable for improving the antenna performance.

Besides, the parasitic antenna has low requirements for thickness and therefore is very applicable to terminals with requirements for antenna thickness.

### BRIEF DESCRIPTION OF THE DRAWINGS

To clearly describe the technical solution in the embodiments of the present disclosure or in the prior art, the following are brief introduction of the attached drawings used to describe the technology in the embodiments or in the prior art. Obviously, the attached drawings described below involve some embodiments of the present disclosure. For a person skilled in the art, other drawings can be made according to those drawings without creative labor

FIG. 1 is a location plane of a parasitic antenna according to an embodiment of the present disclosure.

FIG. 2 is a location plane of a parasitic antenna assembled in a mobile terminal according to an embodiment of the present disclosure.

FIG. 3 is a location plan of an antenna body for a full-metal back cover according to an embodiment of the present disclosure.

FIG. 4 is a diagram of antenna performance comparison between a whole machine configured with a parasitic antenna and a whole machine without a parasitic antenna.

### DESCRIPTION OF THE EMBODIMENTS

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art can obtain other embodiments without creative labor, which shall all fall within the protection scope of the present disclosure.

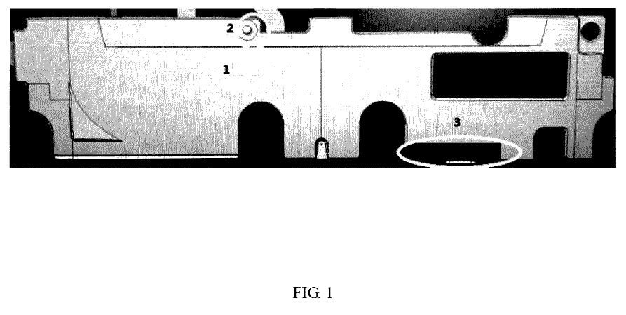

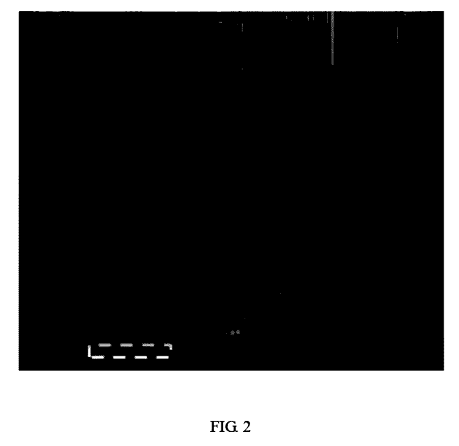

An embodiment of the present disclosure discloses an antenna for a full-metal back cover. As shown in FIG. 1, a loudspeaker box 1 is provided with a parasitic antenna 3. The parasitic antenna 3 is a laser direct structuring (LDS) antenna by laser etching. By using a computer to control laser movement according to trajectories in a conductive pattern, a laser is radiated on mold shaped three-dimensional plastic device, activating a circuit pattern within several seconds. In simple terms (relative to the design and production of mobile phone antennas), a molded plastic bracket is directly chemically plated by laser etching technology to form a metal antenna. As shown in FIG. 2, during assembling of a whole machine, the loudspeaker box configured with the parasitic antenna is assembled inside a mobile terminal, for example, a dotted-line pattern represents the parasitic antenna disposed on the loudspeaker box.

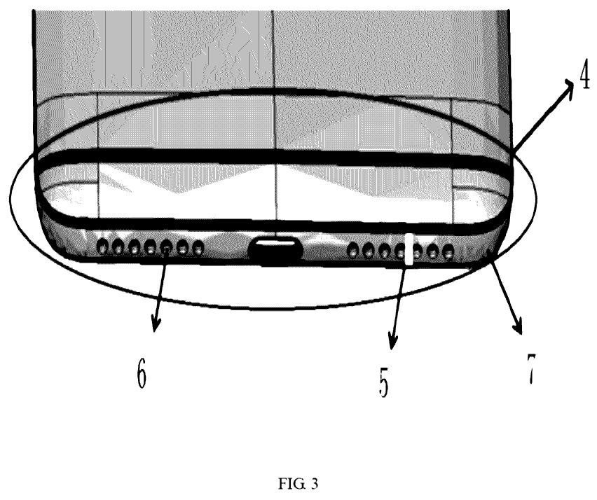

As shown in FIG. 3, an antenna body 4 located on the surface of a metal back cover includes an antenna feed unit and an antenna radiation part, and the antenna radiation part includes at least one branch, and each branch includes at least one radiation arm. In this embodiment, the antenna radiation part consists of a first branch 6 and a second branch 7. The loudspeaker box and the antenna body are both positioned at a lower end of the mobile terminal after assembling. When the mobile terminal is assembled on the full-metal back cover, a precise connector (pogo pin) 2 in FIG 1 is equivalent to an antenna grounding unit of the antenna body. The parasitic antenna resonance part and the antenna radiation part are in a coupled relationship. Here, the parasitic antenna resonance part is coupled with the first branch 6 couple and/or the second branch 7. The first branch 6 is used for generating low-frequency resonance, while the second branch 7 is used for generating high-frequency resonance.

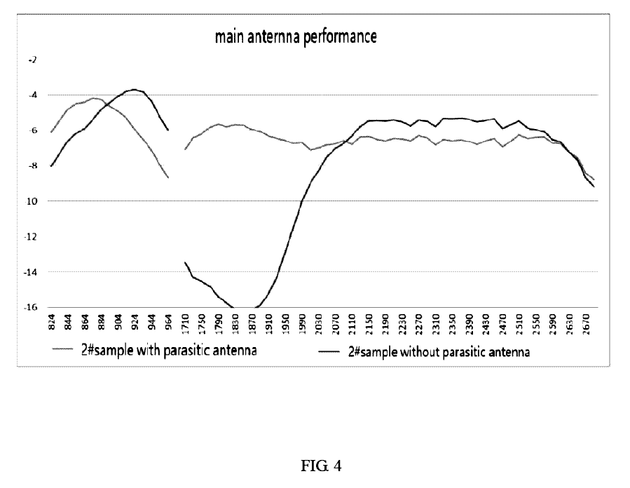

Refer to FIG. 4, which is a diagram of antenna performance comparison between a whole machine configured with a parasitic antenna and a whole machine without a parasitic antenna. From test results in the diagram, the antenna performance in the two statues, namely in the case of the parasitic antenna configured and in the case of no parasitic antenna, can be seen. Obviously, the main antenna of the whole mobile terminal configured with the parasitic antenna can completely realize the design requirements of wide-band. In the embodiment, the frequency of the antenna is switched through the coupling between the parasitic antenna and the metal back cover to meet the wide-band requirements of the antenna. In the embodiment, the tuner at the antenna feed point is canceled, saving cost; the space, occupied by the turner, on the PWB can be excavated, and the increase in the space is also favorable for improving the antenna performance. Besides, the parasitic antenna has low requirements for thickness and therefore is very applicable to terminals with requirements for antenna thickness.

It is needed to be noted that, the parasitic antenna the design solution of the parasitic antenna varies with the environment of the whole machine, and the parasitic antenna does not limit the design solution of the embodiment.

Likewise, the parasitic antenna for the full-metal back cover in the embodiment can be designed in a mobile terminal, for example in a mobile phone. The principle and effect are identical with those of the above embodiment, and therefore are not repeated here.

The device embodiments described above are schematic only, wherein units described as separate components can be or cannot be separated physically; components which are adopted as display units display can be or cannot be physical units, namely located on a place or distributed to a plurality of network units. The purpose of the schemes in the embodiment can be achieved via partial or all modules according to actual requirements. A person skilled in the art can understand and implement without creative labor.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. An antenna for a full-metal back cover, comprising:
a parasitic antenna resonance part disposed on an assembled part in a mobile terminal;
wherein when the mobile terminal is assembled, the position of the parasitic antenna resonance part corresponds to the position of an antenna body disposed on a full-metal back cover; the antenna body comprises an antenna feed unit, an antenna grounding unit and an antenna radiation part; and the parasitic antenna resonance part and the antenna radiation part are coupled.

2. The antenna according to claim 1, wherein,
the parasitic antenna resonance part is disposed on a loudspeaker box;
and the loudspeaker box and the antenna body are both positioned at a lower end of the mobile terminal after assembling.

3. The antenna according to claim 1, wherein,
the parasitic antenna resonance part is a laser direct structuring antenna by laser etching.

4. The antenna according to claim 1, wherein,
the antenna radiation part comprises at least one branch, and each branch comprises at least one radiation arm.

5. The antenna according to claim 1, wherein,
the antenna radiation part comprises two branches, and each branch comprises one radiation arm;
the first branch is used for generating low-frequency resonance, and the second branch is used for generating high-frequency resonance;
and the parasitic antenna resonance part is coupled with the first couple or the second branch.

6. A mobile terminal with a full-metal back over, comprising an antenna system, characterized in that, the antenna system comprises:
an antenna body disposed on the full-metal back cover, the antenna body comprising an antenna feed unit, an antenna grounding unit and an antenna radiation part;
a parasitic antenna resonance part disposed on an assembled part in the mobile terminal;
wherein, when the mobile terminal is assembled, the position of the parasitic antenna resonance part corresponds to the position of the antenna body;
and the parasitic antenna resonance part and the antenna radiation part are coupled.

7. The mobile terminal according to claim 6, wherein,
the parasitic antenna resonance part is disposed on a loudspeaker box;
and the loudspeaker box and the antenna body are both positioned at a lower end of the mobile terminal after assembling.

8. The antenna according to claim 6, wherein,
the parasitic antenna resonance part is a laser direct structuring antenna by laser etching.

9. The antenna according to claim 6, wherein,
the antenna radiation part comprises at least one branch, and each branch comprises at least one radiation arm.

10. The antenna according to claim 6, wherein,
the antenna radiation part comprises two branches, and each branch comprises one radiation arm;
the first branch is used for generating low-frequency resonance, and the second branch is used for generating high-frequency resonance;
and the parasitic antenna resonance part is coupled with the first couple or the second branch.

11. The antenna according to claim 1, wherein,
the antenna radiation part comprises two branches, and each branch comprises one radiation arm;
the first branch is used for generating low-frequency resonance, and the second branch is used for generating high-frequency resonance.
and the parasitic antenna resonance part is coupled with the first couple and the second branch.

12. The antenna according to claim 6, wherein,
the antenna radiation part comprises two branches, and each branch comprises one radiation arm;
the first branch is used for generating low-frequency resonance, and the second branch is used for generating high-frequency resonance.
and the parasitic antenna resonance part is coupled with the first couple and the second branch.
